(19) United States
(12) Patent Application Publication
(10) Pub. No.: US 2016/0200987 A1
(43) Pub. Date: Jul. 14, 2016

(54) Forced Gas Recirculation in Later Stage Refining Processes and Reactors

(71) Applicant: SYNPET TEKNOLOJI GELISTIRME A.S., Istanbul (TR)

(72) Inventors: Brian S. Appel, West Hempstead, NY (US); Jonathan Appel, West Hempstead, NY (US); James H. Freiss, Blue Point, NY (US)

(21) Appl. No.: 14/913,424

(22) PCT Filed: Aug. 22, 2014
(86) PCT No.: PCT/US2014/052359

§ 371 Date: Feb. 22, 2016

Related U.S. Application Data
(60) Provisional application No. 61/868,937, filed on Aug. 22, 2013.

(51) Int. Cl. C10G 9/00; B01J 19/00; B01J 19/18; C10L 1/04

(52) U.S. Cl. CPC C10G 9/00; C10L 1/04; B01J 19/0013; B01J 19/18; C10L 2200/0469; C10L 2290/10; C10L 2290/543; B01J 2219/00108; B01J 2219/00162; B01J 2219/00164

(57) ABSTRACT

In later stage hydrocarbon fuel refining processes involving cracking reactions for upgrading hydrocarbon containing feeds into liquid and gaseous hydrocarbon fuels, the ration of liquid to gaseous recovery is advantageously increased by forced recirculation of non-condensing gas into cracking reaction.

### RELATED APPLICATION DATA

This application claims the benefit of priority of U.S. Provisional Patent Application Ser. No. 61/868,937, filed Aug. 22, 2013, and titled “Forced Gas Recirculation in Renewable Diesel Refining Reactor”, which is incorporated by reference herein in its entirety.

### FIELD OF THE INVENTION

The present invention generally relates to the fields of refining processes and renewable fuels production. In particular, the present invention is directed to systems and methods for increasing yields of the liquid hydrocarbon fraction produced in later stage refining processes and reactors.

### BACKGROUND

Renewable diesel oil (RDO) can be made from a variety of waste raw materials. One well known material or feedstock is waste oil from commercial kitchen fryers, which is converted to RDO through processes of hydrocracking or hydrogenation. In some cases further refining of pyrolytic oils may produce RDO. Other raw material or feedstocks, such as agricultural food wastes, municipal solid waste, sewage sludge or auto shredder residue, can be converted to RDO through a process developed by the present Applicant and described, for example, in U.S. Pat. No. 7,692,050, entitled “Apparatus and Process for Separation of Organic Materials From Attached Insoluble Solids, and Conversion Into Useful Products.”

In RDO processes such as those mentioned above, final or later stage processing generally comprises a form of upgrade treatment that is often in many respects similar to or the same as known later stage petroleum refining processes, such as hydrotreatment, delayed coking or other cracking processes. However, in many instances, liquid fuels produced from renewable sources, for example the RDO produced from condensable vapors, are commercially favored over gaseous hydrocarbon fuels such as methane that are a common and valuable byproduct of conventional petroleum refining processes.

Reasons for a preference for renewable liquid versus gaseous fuels may arise because liquids (RDO) can be sold to third parties at greater distances from the production facility, whereas gaseous fuels are less mobile and generally must be utilized at or near the production facility, as infrastructure (pipelines for example) for transport are capital intensive and thus cost prohibitive. Oil products also have greater value on a BTU equivalent basis. These cost and convenience factors may be exacerbated in the current market structure where renewable producers tend to be newer, smaller entities that operate on smaller margins with less established distribution networks as compared to traditional petroleum refining operations. However, regardless of the reasons, there is in many instances a preference for renewable liquid fuels over gaseous fuels.

### SUMMARY OF THE DISCLOSURE

Embodiments described herein may be employed to increase the ratio of liquid hydrocarbons or hydrocarbon containing compounds or molecules to gaseous hydrocarbons or hydrocarbon containing compounds in later stage refining type processes such as hydrotreatment, delayed coking and other cracking based processes. While initial motivation for increasing the ration of liquid to gaseous fuels produced in such processes may be present in renewable fuels processing, embodiments described herein are equally applicable to all suitable hydrocarbon feeds, regardless of their source.

In one exemplary method, a suitable hydrocarbon compound containing feed is provided in a reaction vessel. The feed is subjected to a cracking reaction in the reaction vessel. Vapors produced in the cracking reaction are removed through a reaction vessel outlet. A condensable fraction of the removed vapors is condensed to produce at least one liquid hydrocarbon and non-condensing gases from the removed vapors are recycled back into the reaction vessel. In a further exemplary embodiment the recycling is at a volumetric flow rate exceeding a normal vapor exit volumetric flow rate.

In one exemplary system, a reaction vessel is configured to receive a processed hydrocarbon feed through a feed inlet. The vessel may have a vapor outlet and a recirculation injection port. The vessel further may be configured to withstand pressures of at least about 3 bar and temperatures of at least about 600° C. A mixer with a mixing element extends into the reaction vessel and is configured to impart sufficient energy to the processed hydrocarbon feed to create non-laminar conditions in the reaction vessel. At least one downstream condenser and liquid separation means communicate with the vessel vapor outlet to receive vapors therefrom and have an outlet for non-condensing gas. A recirculation line connects the non-condensing gas with the reaction vessel recirculation injection port to reintroduce non-condensing gas back into the reaction vessel. Means, such as a blower or centrifugal pump, may be disposed in the recirculation line to control the volumetric flow rate of non-condensing gas reintroduction into the reaction vessel.

In a further exemplary system, a control system including processor, memory and user interface means are configured to provide and execute control instructions for various system parameters such as the volumetric flow rate of recirculated gas into the vessel. In one embodiment, instructions are provided and executed to control the volumetric flow rate of the recirculated gas to exceed a normal vapor exit volumetric flow rate. In another embodiment, instructions are provided and executed to maintain the temperature in the reaction vessel to be in the range of approximately 400-600° C., and to maintain the pressure in the vessel to be in a range of approximately 0.5 to 70 psig.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram illustrating process flow and processing equipment as may be employed in a system according to one exemplary embodiment of the present invention.

FIG. 2 is a flow diagram illustrating one example of a process for producing a processed hydrocarbon feed according to an embodiment of an invention.

### DETAILED DESCRIPTION

Embodiments of the invention include apparatus and methods for increasing recovery of desirable liquid or condensable hydrocarbon containing compounds or molecules from later stage processing of residual oils and other pre-processed hydrocarbon feeds, such as typical feeds into delayed coking and other hydrocarbon cracking processes. Embodiments include forced recirculation of a fraction of the vapors evolving from the reactor headspace and/or temperature control in the reactor headspace to beneficially effect the time at temperature experienced by recoverable/condensable vapors in the reaction zone.

In general, vapors produced through cracking reactions in refining processes (or through other physical processes such as boiling or volatilization) are removed from the reactor utilizing a pressure drop from the inside to the outside of the reactor. This pressure drop is caused by the partial pressures of the volatile compounds evolving from the feed material through the processes of the reaction. When feed material consisting of hydrocarbons or hydrocarbon containing compounds or molecules approaches a temperature that provides adequate energy for cracking reactions (typically about 400-600° C.), molecules of long and/or short chain hydrocarbons begin to be released into the headspace of the reactor. These compounds exert a partial pressure to the headspace in the reactor (as reactors are enclosed containers). The partial pressure from these vapors/gases builds additively until the normal operating pressure of the reactor is achieved. At that point compounds begin to flow from the reactor to other downstream processes for condensing, separation and other treatments. Vapor flow from the reactor under these conditions is typically controlled through the use of automated valving or similar mechanical device(s) using reactor pressure as a feedback mechanism for opening and closing valve to downstream processes. As will be recognized by persons of ordinary skill, different constituents of the hydrocarbons will crack at different levels of energy input dictated by reactor temperature, residence time and rate of reaction(s), such that the gaseous outflow will include a mixture of condensable longer chain hydrocarbons and non-condensing shorter chain hydrocarbons. Condensable vapor (or gas) in this application refers to vapors comprising compounds/molecules of sufficient molecular weight to change phase from vapor to a liquid at applicable downstream operating temperatures for the specific process, which, in most refining processes, is at or near ambient atmospheric conditions. Non-condensing gas, as the term is used herein, thus refers to shorter chain hydrocarbons that will not undergo a vapor to liquid phase change at the applicable downstream operating temperatures (e.g., methane gas or constituent gases in LPG). Depending on the original feedstock material, non-condensing gas may also include inert gases (e.g. nitrogen or carbon dioxide).

In exemplary embodiments, the time at temperature may be addressed through forced recirculation of a fraction of the vapors evolving from reactor headspace after much of the condensable hydrocarbons have been removed through cooling or other means of separation of the gas stream. Such recirculation preferably occurs continuously while the reactor is maintained at the reaction temperature. The recirculated gas is at a temperature equivalent to or, in some embodiments, below that of the reactor conditions for cracking and at a volumetric flow rate preferably, but not necessarily, several times higher than the actual volumetric rate of gas evolving from the reactor without recirculation. After removal of condensable hydrocarbons, typically the recirculated fraction will comprise primarily non-condensing gases.

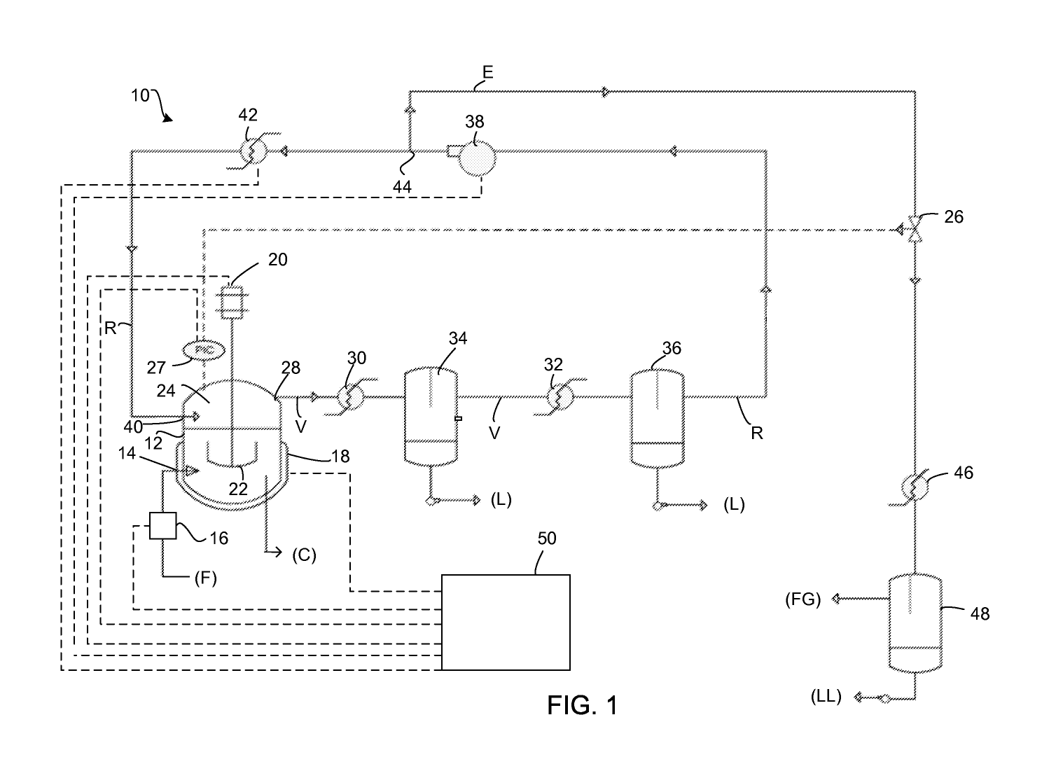

Turning to FIG. 1, further details of one exemplary embodiment are described. In system 10, the preprocessed hydrocarbon feed (F) enters reactor vessel 12 at inlet 14. A pump, conveyor or other appropriate means 16 for the feed type may be used to control flow rate and pressure. Reactor 12 is raised to operating temperature by heat source 18. Typically, operating temperature will be in the hydrocarbon cracking range, for example in the range of approximately 400-600° C. Heating may be a combination of electric resistance/induction, thermal fluid, steam, indirect heat from flue gas, etc. that will economically provide the desired operating temperature and as may be devised by a person of ordinary skill in the art.

While feed (F) is heated in reactor 12, mixing may be utilized to increase surface area between feed material and reactor head space thus encouraging more rapid evolution of volatiles from the feed material as they are produced as the temperature of the incoming material reaches a minimum temperature for said evolution. Mixing can also speed reaction kinetics between feed material and any reagent (such as hydrogen) added. Mixer 20 may be a top entry blade mixer (blade 22) or other mixing system as known by those skilled in the art. Other examples include but are not limited to scraped wall-type mixers or tumbling and conveying action of a rotary kiln for example. Addition of a reagent such as hydrogen at this stage could be used to further saturate or tie up radical bonds.

Mixing conditions in reactor 12 preferably involve a form of vigorous mixing. In some embodiments, mixing is done with sufficient energy to create non-laminar conditions or at a Reynolds number sufficient (for example above 4000-5000) to create non-laminar conditions in consideration of the physical characteristics of feed (F) effecting flow and heat transfer, such as density, viscosity, thermal conductivity and Prandtl number.

In certain embodiments, pressure in reactor 12 is maintained at approximately one to three (1-3) bar to encourage more rapid vapor evolution and minimal gas density in head space 24 above feed (F). As discussed in more detail below, pressure is controlled by pressure letdown valve 26, communicating with pressure sensor 27 in reactor 12. Operation in such a lower pressure range can provide added advantages such as increased cost effectiveness by reducing the demands placed on the reactor and other process components. However, in other embodiments, pressures higher than three bar may be used. For example, depending on the physical and chemical makeup of the preprocessed hydrocarbon feed (F), resulting for example from different original feedstocks and/or different upstream processes, higher pressures may decrease necessary time at temperature for low molecular weight volatile compounds to crack before exiting reaction zones. Higher pressures may also be desirable if a processing aid such as hydrogen is used in reactor 12. In general, higher reactor pressures (e.g. above 3 bar) will not fundamentally change the operation of downstream components as described hereinafter, other than to require adequate design consistent with the selected operation pressure.

After sufficient residence time, carbon and any remaining inorganic solids (C) exit reactor 12 through a bottom outlet and vapor stream (V) exits reactor 12 through outlet 28. Downstream from reactor 12, vapor stream (V) is directed through one or more condensers to cool gases produced in the reactor after they leave reaction zone headspace 24.

In the exemplary embodiment of system 10 shown in FIG. 1, two downstream condensers are employed. In this example, condensers 30, 32 are respectively paired with disengagement vessels 34, 36. Alternatively other means of separation may comprise, for example, molecular sieves or other suitable means as may be determined by persons of ordinary skill based on the physical and chemical makeup of vapor stream (V), which in turn is largely dependent upon the characteristics of feed (F). The gases making up vapor stream (V) typically will be a combination of organic and inorganic, condensable and non-condensable compounds. Condensers 30, 32 suitably cool the vapor stream, such as by water or other appropriate cooling medium in non-contact heat exchangers. Shell and tube type heat exchangers are one non-limiting example. Other exchanger types with similar cooling capabilities may be selected by persons of ordinary skill.

Outlet temperatures for each of condensers 30, 32 are controlled, for example via continuous temperature monitoring coupled with a process controller to adjust coolant flows to said condensers, so that the condensed hydrocarbon liquids in the disengagement vessels 34, 36 downstream of each condenser are consistent from a petroleum/industrial chemical recovery standpoint. For example, a bunker oil will condense at greater than about 315° C., whereas a gasoline species will condense at temperatures in the range of approximately 40 to 200° C. Thus, utilizing multiple condensers and downstream disengagement vessels, different fuels may be roughly separated as the vapors are reduced to ambient conditions. (Additionally or alternatively, there may be a desire to roughly cut heavy oil from distillate oil utilizing intrinsic system energy to reduce system complexity to provide capital and energy savings).

Disengagement vessels 34, 36 may comprise conventional phase separation vessels, tanks or other liquid/gas separators suitable for oil/vapor separation at process conditions. The disengagement vessels also may be integrated with the condensers or separately provided as shown in the exemplary embodiment of FIG. 1. Condensed hydrocarbon liquids (L) are removed from the bottom of disengagement vessels 34, 36. Dependent upon factors such as the makeup of feed (F) and the processing conditions in reactor 12, hydrocarbon liquids (L) may have characteristics of diesel oil or fuel oil produced from coker gas oil or fluid catalatic cracking (FCC) gas oil.

After at least most condensable hydrocarbons have been removed from vapor stream (V) via condensing and separation as described, remaining non-condensing gases form recirculation stream (R). Unless otherwise controlled, recirculation stream (R) will be initially at the outlet temperature of the last exchanger/disengagement vessel (vessel 36 in the exemplary embodiment of FIG. 1). Recirculation stream (R) including the non-condensing gases is re-circulated to reactor 12 via means such as a centrifugal or positive displacement blower 38. Recirculation stream (R) is preferably maintained at a temperature range below that of the reaction zone in reactor 12, for example between approximately 100° C. and 200° C., but may be as high as the reaction zone temperature (approximately 400° C.-600° C.). Thus, an overall workable temperature range for recirculation stream (R) in different embodiments is from about 100° C. to about 600° C.

Recirculation stream (R) is delivered back into headspace 24 of reactor 12 through injection port 40. Injection port 40 is physically spaced from outlet 28, preferably spaced as far as possible given the reactor design, to encourage plug flow conditions through headspace 24. For example, injection port 40 may be located diametrically with respect to outlet 28 in one or both of the horizontal and vertical dimensions of headspace 24. (Maximizing the physical separation of injection port 40 and outlet 28 within headspace 24 may be especially important in plug flow reactor designs such as a horizontal rotary kiln where the length to diameter ratio is high).

Blower 38 and piping associated with recirculation stream (R) should be sized and configured in consideration of a predicted volumetric flow rate from the reactor as would normally occur at the specified reactor operating conditions without re-circulation. In one embodiment, the volumetric flow rate of recirculation stream (R) through blower 38 is between 2 and 10 times the predicted normal volumetric flow rate at the specified reactor conditions. Without intending to be bound by theory, it is believed that this relatively higher rate of recirculation of non-condensable gases through recirculation stream (R) beneficially alters reactor headspace conditions to increase the recoverable fraction of liquid hydrocarbons. For example, the relatively high volumetric flow rate of recirculation stream (R) into headspace 24 may minimize evolving vapor's exposure to reaction temperature, thus reducing cracking to shorter chain molecules and thereby increasing longer chain molecule yields that provide liquid hydrocarbons. Also, when recirculation stream (R) is maintained at a temperature below the reaction temperature time at temperature experienced by evolving vapor in reactor 12, headspace 24 also may be effectively reduced. In this regard, in a further alternative embodiment, gas tempering exchanger 42 may be included in recirculation stream (R) so that the temperature of gases entering the reactor headspace at injection port 40 can be controlled independently of the condensing of hydrocarbons from the reactor vapor outflow. Recirculation stream (R) is pressure regulated via let down valve 26 communicating with pressure sensor 27 in reactor 12. Exhaust stream (E) branches off recirculation stream (R) at point 44, downstream from blower 38, and may be directed to further processing, such as additional condensers 46 and/or disengagement vessels 48 dependent upon its makeup. Fuel gas (FG) and other light hydrocarbon liquids (LL) may be typical products from exhaust stream (E).

In some embodiments it may be desirable to implement automated control of one or more system components. In such an embodiment, control system 50 may be optionally employed. Control system 50 generally includes processors, memory, at least one user interface and other hardware, software and/or firmware as may be implemented by persons skilled in the art to automate process controls according to the teachings herein contained. For this purpose, communication between control system 50 and components such as pump means 16, vessel heating 18, mixer 20, pressure control sensor 27 and valve 26, heat exchanger 42 for controlling recirculated gas temperature and/or recirculation blower/pump 38 may be unidirectional or bidirectional to provide for feedback control as indicated by dashed lines in FIG. 1. Pumps, blowers, valves and other control devices for other system components such as heat exchangers, condensers and disengagement vessels also may be controlled by control system 50. For this purpose, control system 50 may be configured to execute control instructions for corresponding system components to provide reaction, recirculation and other system conditions as described herein.

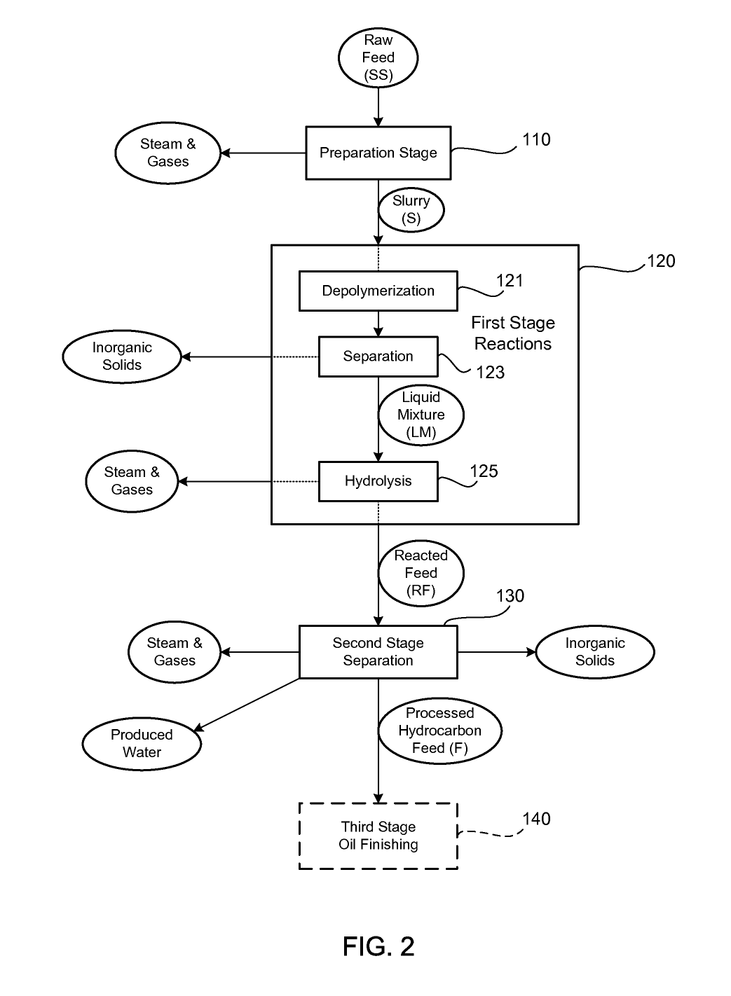

FIG. 2 illustrates the process flow for the sewage sludge feedstock used to produce the processed hydrocarbon feed (F) that was the subject of the experimental results described below. This process flow is just one example of a process that is suitable for providing an appropriate feed (F) for systems and methods employing the teachings described herein, including system 10 in FIG. 1. Examples of other processes or hydrocarbon feeds suited for further processing as described herein include biomass derived hydrocarbon liquids produced from pyrolytic or gasification processes; cooking or frying waste oils after conventional hydrotreatments; in some cases virgin or lightly used vegetable or other plant based oils, or various waste or slop oil streams from conventional petroleum processes. Virtually any hydrocarbon containing feed that is suitable for upgrading to hydrocarbon fuel streams via conventional cracking processes can have its recoverable liquid hydrocarbon fuel increased by applying the teachings of the present invention.

Turning again to FIG. 2 the sewage sludge raw feed (SS) was initially provided in solid cake form as received from the sewage plant. Preparation stage 110 involved grinding to reduce particle size and add moisture to create a flowable slurry (S). Moisture content and other constituents of slurry (S) as input into first stage reactions 120 are given in Tables I and II below under INPUTS (1^{st} Stage). The sewage sludge slurry was first subjected to depolymerization reaction 121 at temperatures in the range of about 170-200° C. The depolymerization reaction breaks down the slurry and separates inorganic solids, which are removed in separation 123 to form liquid mixture (LM) from which most inorganic solids are removed. The liquid mixture is then subjected to hydrolysis reaction 125 at temperatures in the range of about 200-270° C. Pressure in the hydrolysis reaction is generally maintained at a level above the saturation point of water in the liquid mixture to prevent boiling off of water used in the hydrolysis reaction. Gases vented from hydrolysis reaction 125 allow for removal of many contaminants at this stage. First stage reactions 120 produce a reacted feed (RF) that comprises primarily a mixture of liquid hydrocarbons, water and some remaining inorganic solids.

Reacted feed (RF) is directed to second stage separation 130 wherein various liquid-liquid and liquid solid separations are conducted to produce the processed hydrocarbon feed (F). These separations remove much of the moisture as produced water and most if not all remaining entrained inorganic solids are also removed at this stage. Processed hydrocarbon feed (F) is then delivered to a third stage oil finishing process 140, which, in the case of test results provided below, comprised a system 10 substantially as shown in FIG. 1. Moisture content and other constituents of feed (F) into the third stage reaction are given in Tables I and II below under INPUTS (3^{rd} Stage). Further details and descriptions of the process for producing processed hydrocarbon feed (F) as shown schematically in FIG. 2 are provided in Applicant's Patent Publication No. US 2009/0062581, entitled “Methods And Apparatus For Converting Waste Materials Into Fuels And Other Useful Products,” which is incorporated by reference in its entirety herein.

### Experimental Results

A series of tests involving four separate runs were performed to evaluate embodiments of the present invention. The processed hydrocarbon feed (F) for these tests was derived from a sewage sludge feedstock processed as illustrated in FIG. 2 and described in more detail below. Data generated from these tests is presented in Tables I and II below.

In Runs 1 and 2, the processed hydrocarbon feed (F) was subjected to conventional cracking reaction conditions comprising a generally static method of applying heat and extracting gas and oil from the feed via pressure developed in the reactor by the feed itself (water and organic vapor pressure) at the reaction conditions, in this case generally at temperatures from ambient to about 537° C. With recirculation stream (R) and exhaust stream (E) removed, the process/apparatus was otherwise substantially as illustrated in FIG. 1. Results of Runs 1 and 2 are shown in Table I:

TABLE I

| | Run 1 | | | | | | Run 2 | | | | |
|---|---|---|---|---|---|---|---|---|---|---|---|
| | Total | Moisture | Ash | Fat | Balance | | Total | Moisture | Ash | Fat | Balance |
| INPUTS | | | | | | INPUTS | | | | | |
| (1^{st} Stage) | | | | | | (1^{st} Stage) | | | | | |
| Percentage | 100 | 72.795 | 5.46 | 3.8 | 17.945 | Percentage | 100 | 72.795 | 5.46 | 3.8 | 17.945 |
| Grams | 1524.5 | 1109.76 | 83.24 | 57.93 | 273.57 | Grams | 1518.8 | 1105.62 | 87.93 | 57.51 | 272.55 |
| INPUTS | | | | | | INPUTS | | | | | |
| (3rd Stage) | | | | | | (3rd Stage) | | | | | |
| Percentage | 100 | 58.55 | 16.011 | 20.57 | 4.869 | Percentage | 100 | 30.696 | 19.089 | 24.129 | 26.086 |
| Grams | 375.1 | 219.62 | 60.06 | 77.16 | 18.26 | Grams | 302 | 92.7 | 57.65 | 72.87 | 78.78 |

| OUTPUTS | | | | OUTPUTS (3^{rd} | | | |
|---|---|---|---|---|---|---|---|
| (3^{rd} Stage) | Percent | Normalized | | Stage) | Percent | Normalized | |
| Carbon | 6.2 | 6.9 | Outputs as | Carbon | 5.7 | 6.5 | Outputs as |
| Oil | 2.8 | 3.1 | produced and | Oil | 1.8 | 2.1 | produced and |
| Gas | 6.6 | 7.3 | normalized to | Gas | 3.9 | 4.5 | normalized to |
| Water | 74.2 | 82.7 | eliminate | Water | 76.2 | 86.9 | eliminate |
| Handling and | 10.3 | NA | sampling and | Handling and | 12.4 | NA | sampling and |
| Sampling | | | handling losses | Sampling | | | handling losses |
| Total | 100.0 | 100.0 | | Total | 100.0 | 100.0 | |

| | |
|---|---|
| RDO as a percent of measured extractable fat entering reaction: | Percentage of Raw: |

| | | | |
|---|---|---|---|
| Avg Grams Measured as solvent extractable: | 75.0 Grams | Avg Gas | 5.9 |
| Avg Grams of Raw Material Extracted as RDO: | 35.2 Grams | Avg Oil | 2.6 |
| Avg Percentage of RDO extracted: | 47.0% | Avg Total | 8.5 |

In Runs 3 and 4, operating conditions in the reactor and system equipment were substantially the same as for Runs 1 and 2; however, forced recirculation of non-condensing gases into reactor headspace 24 through recirculation stream (R) (also with exhaust stream (E)), substantially as shown and described above, was employed. The forced recirculation of non-condensing gases in Runs 3 and 4 provided a reduced headspace residence time of between about one-half to about one-tenth of the residence time in Runs 1 and 2. Results of Runs 3 and 4 are shown in Table II:

TABLE II

| | Run 3 | | | | | | Run 4 | | | | |
|---|---|---|---|---|---|---|---|---|---|---|---|
| | Total | Moisture | Ash | Fat | Balance | | Total | Moisture | Ash | Fat | Balance |
| INPUTS | | | | | | INPUTS | | | | | |
| (1^{st} Stage) | | | | | | (1^{st} Stage) | | | | | |
| Percentage | 100 | 72.795 | 5.46 | 3.8 | 17.945 | Percentage | 100 | 72.795 | 5.46 | 3.8 | 17.945 |
| Grams | 1400 | 149.13 | 76.44 | 53.2 | 251.23 | Grams | 1455.39 | 1059.39 | 79.46 | 55.3 | 261.15 |
| INPUTS | | | | | | INPUTS | | | | | |
| (3rd Stage) | | | | | | (3rd Stage) | | | | | |
| Percentage | 100 | 35.043 | 18.08 | 21.257 | 25.62 | Percentage | 100 | 37.129 | 17.919 | 23.458 | 21.494 |
| Grams | 300.8 | 105.41 | 54.38 | 63.94 | 77.06 | Grams | 330.1 | 122.56 | 59.15 | 77.43 | 70.95 |

| OUTPUTS | | | | OUTPUTS | | | |
|---|---|---|---|---|---|---|---|
| (3^{rd} Stage) | Percent | Normalized | | (3^{rd} Stage) | Percent | Normalized | |
| Carbon | 7.0 | 8.0 | Outputs as | Carbon | 6.3 | 7.3 | Outputs as |
| Oil | 4.8 | 5.6 | produced and | Oil | 4.6 | 5.3 | produced and |
| Gas | 3.3 | 3.8 | normalized to | Gas | 3.6 | 4.1 | normalized to |
| Water | 71.9 | 82.6 | eliminate | Water | 72.1 | 83.2 | eliminate |
| Handling and | 13.0 | NA | sampling and | Handling and | 13.4 | NA | sampling and |
| Sampling | | | handling losses | Sampling | | | handling losses |
| Total | 100.0 | 100.0 | | Total | 100.0 | 100.0 | |

| | |
|---|---|
| RDO as a percent of measured extractable fat entering reaction: | Percentage of Raw |

| | | | |
|---|---|---|---|
| Avg Grams Measured as solvent extractable: | 70.7 Grams | Avg Gas | 4.0 |
| Avg Grams of Raw Material Extracted as | 67.6 Grams | Avg Oil | 5.5 |
| RDO: | | | |
| Avg Percentage of RDO extracted: | 95.6% | Avg Total | 9.4 |

The data presented in Table II from Runs 3 and 4 show doubling of condensable oil on a mass basis and a similar reduction in the production of gaseous organic compounds on a mass basis as compared to the data presented in Table I from Runs 1 and 2. As previously discussed, and again while not intending to be bound by theory, it is believed that shorter residence times at temperature in the reactor headspace promote less cracking and thus increase the average molecular weight of the end products. This shift in the relationship between oil and gas toward favoring more oil production was an unexpected, beneficial result of the present invention, as shown in these experimental results.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method, comprising:
providing a hydrocarbon compound containing feed in a reaction vessel;
subjecting said feed to a cracking reaction in the reaction vessel;
removing vapors produced in the cracking reaction, said vapors removed through a reaction vessel outlet;
condensing a condensable fraction of the removed vapors to produce at least one liquid hydrocarbon; and
recycling non-condensing gases from the removed vapors back into the reaction vessel.

2. The method of claim 1, wherein said recycling is at a volumetric flow rate exceeding a normal vapor exit volumetric flow rate, the normal vapor exit volumetric flow rate corresponding to the flow rate of vapor through the outlet that would be created by vapor production in the reaction vessel at said reaction conditions absent said recycling.

3. (canceled)

4. The method of claim 2, wherein said recycling comprises recycling only non-condensing gases.

5. The method of claim 4, wherein said subjecting said feed to a cracking reaction comprises:
heating the feed to temperatures of in the range of approximately 400-600° C.; and
controlling pressure to be in a range of approximately 0.5 to 70 psig.

6. The method claim 1, wherein said recycling comprises continuously forcing the non-condensing gas back to the reaction vessel during the cracking reaction.

7. (canceled)

8. The method of claim 6, further comprising adding a reagent to the recycled non-condensing gas and enhancing reagent interaction in solid, liquid and gas phases in the cracking reaction by controlling the pressure at a level above approximately 3 bar.

9. (canceled)

10. The method of claim 6, further comprising condensing and removing water from the removed vapors.

11. (canceled)

12. The method of claim 10, further comprising controlling the temperature of the recycled gas below the temperature of the cracking reaction.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A system for forced recirculation of gases in a reactor to improve liquid yields of hydrocarbon or hydrocarbon containing compounds or molecules, comprising an apparatus of a heated pressure vessel, means to recycle some of the exiting gases/vapor from the reactor, condensing system, multiple disengagement vessels, pressure and temperature gages and controls, condensed liquids storage, and piping connections therebetween.

25. The system of claim 24, further comprising a mixer with a mixing blade extending into the pressure vessel to increase reaction kinetics to cause faster evolution of hydrocarbons from the liquid or solid phase during the cracking reactions.

26. The system of claim 24, wherein said vessel is configured for temperatures of approximately 400-600° C. and pressures in the range of 0.5 to 70 psig.

27. The system of claim 24, further characterized in that:
an exit gas line branches off the recycle line at a point downstream from the means for control of the volumetric flow of non-condensing gas;
a control valve is disposed in the exit gas line to control pressure in the vessel; and
a pressure sensor is disposed in the vessel to control the control valve.

28. The system of claim 27, further characterized in that a heat exchanger is disposed in the recycle line to control the temperature of non-condensing gases reintroduced to the vessel.

29. The system of claim 28, further characterized in that the recirculated gas is injected into the vessel at an injection point diametrically spaced from the removal point of produced vapors.

30. The system of claim 29, further comprising a control system including processor and memory means configured to execute control instructions comprising instructions for controlling the volumetric flow rate of recirculated gas into the vessel to exceed a normal vapor exit volumetric flow rate, the normal vapor exit volumetric flow rate corresponding to the flow rate of vapor exiting the vessel as would be created by vapor production in said vessel at the reaction conditions absent said recirculating.

31. The system of claim 30, wherein the control system is further configured to execute instructions for:
maintaining the temperature in the vessel to be in the range of approximately 400-600° C.;
maintaining the pressure in the vessel to be in a range of approximately 0.5 to 70 psig;
continuously forcing the non-condensing gas back to the reaction vessel during the cracking reaction.

32. (canceled)

33. (canceled)

34. (canceled)

35. (canceled)

36. (canceled)

37. The system of claim 30, wherein the control system is further configured to execute instructions for said maintaining the temperature of the recirculated gas below the temperature of the cracking reaction.

38. (canceled)

39. (canceled)

40. (canceled)

41. (canceled)

42. (canceled)

43. (canceled)

44. A method of increasing the ratio of liquid to gaseous hydrocarbon fuels produced by subjecting a hydrocarbon containing feed to a hydrocarbon cracking reaction, removing vapors produced in the reaction and condensing condensable hydrocarbon vapors in the removed vapors to form liquid carbon fuels, characterized by recycling non-condensing gases from the cracking reaction back into the cracking reaction at a volumetric flow rate greater than a volumetric exit flow rate of vapors produced in the cracking reaction absent said recycling.

45. The method of claim 44, further comprising controlling pressure in the cracking reaction to be in a range of approximately 1 to 3 bar.

46. The method of claim 44, further comprising controlling the recycled gas temperature to be in the range of about 100-400° C.

47. The method of claim 44, further comprising increasing evolution of hydrocarbon vapors from solid and liquid phases by mixing the feed during the cracking reaction to increase reaction kinetics.

48. The method of claim 44, wherein said recycling comprises reintroducing the recycled gas to the cracking reaction at an injection point diametrically spaced from the removal point of produced vapors
